(19) United States
(12) Patent Application Publication
(10) Pub. No.: US 2012/0119900 A1
(43) Pub. Date: May 17, 2012

(54) WIRELESS EMERGENCY VEHICLE LIGHT AND SIREN KIT

(75) Inventors: Dane Robinson Walther, Madison, AL (US); Edward DeWayne McAbee, JR., Moulton, AL (US); Edward Christian Sipple, IV, Lake View, AL (US)

(73) Assignee: Lewis Innovative Technologies

(21) Appl. No.: 13/157,984

(22) Filed: Jun. 10, 2011

Related U.S. Application Data
(60) Provisional application No. 61/413,644, filed on Nov. 15, 2010.

(51) Int. Cl. B60Q 1/26; B60Q 5/00

(52) U.S. Cl. 340/474

(57) ABSTRACT

A wireless system for an emergency vehicle includes at least one siren module, at least one light module, and a remote control in communication with the at least one siren module and the at least one light module. Each of the at least one siren module, at least one light module and remote control are programmable for facilitating selective communication.

### CROSS REFERENCE TO RELATED APPLICATIONS

This application claims the benefit of U.S. Provisional Patent Application Ser. No. 61/413,644, entitled “WIRELESS ALARM SYSTEM”, filed Nov. 15, 2010.

This invention was made with government support under Contract No. W91CRB-08-C-0034 awarded by Technical Support Working Group, Arlington, Va. 22215. The government has certain rights in the invention.

### BACKGROUND OF THE INVENTION

1. Field of the Invention

The invention relates a wireless alarm system, more particularly, wireless emergency vehicle light and siren kit.

2. Description of the Related Art

While many vehicles are fabricated with the specific intention of being a dedicated vehicle, it sometimes becomes necessary to convert a conventional vehicle into an emergency vehicle. The present invention provides a system for converting a vehicle for use as an emergency vehicle in an efficient and cost effective manner.

### SUMMARY OF THE INVENTION

It is, therefore, an object of the present invention to provide a wireless system for an emergency vehicle including at least one siren module, at least one light module, and a remote control in communication with the at least one siren module and the at least one light module. Each of the at least one siren module, at least one light module and remote control are programmable for facilitating selective communication.

It is also an object of the present invention to provide a wireless system wherein at least 4 light modules are included.

It is another object of the present invention to provide a wireless system wherein the at least one siren module includes an integral mounting bracket.

It is a further object of the present invention to provide a wireless system wherein the at least one light module includes a mounting bracket.

It is also an object of the present invention to provide a wireless system wherein multiple mounting brackets are included, and the mounting brackets include an L-shaped mounting bracket, spring hinge mounting bracket and a hinged mounting bracket.

It is another object of the present invention to provide a wireless system wherein the at least one light module includes an ALL OFF command turning off the complete system.

It is a further object of the present invention to provide a wireless system wherein the at least one siren module includes an infrared configuration port.

It is also an object of the present invention to provide a wireless system wherein the at least one siren module includes a unique identification number in memory.

It is another object of the present invention to provide a wireless system wherein the at least one siren module includes a volatile memory and a non-volatile memory.

It is a further object of the present invention to provide a wireless system wherein the at least one light module includes an infrared configuration port.

It is also an object of the present invention to provide a wireless system wherein the at least one light module includes a unique identification number in memory.

It is another object of the present invention to provide a wireless system wherein the at least one light module includes a volatile memory and a non-volatile memory.

It is a further object of the present invention to provide a wireless system wherein the remote control includes a lights ON/pattern select button, a lights OFF/temporary configuration button, a siren ON/tone select button, a siren OFF/permanent configuration button, and a horn blast button.

It is also an object of the present invention to provide a wireless system wherein the remote control includes an infrared configuration port.

It is another object of the present invention to provide a wireless system wherein each remote control is associated with a unique unit identification number and each of the at least one siren module and at least one light module store a unique identification number in memory.

It is a further object of the present invention to provide a wireless system wherein the remote control issues data packets with the associated unique unit identification number allowing for control of light and siren modules associated with the same unique unit identification number.

It is also an object of the present invention to provide a wireless system wherein the remote control issues the data packets using RF communications.

It is another object of the present invention to provide a wireless system wherein the remote control, at least one siren module and at least one light module communicate via IrDA.

It is a further object of the present invention to provide a wireless system wherein each remote control is associated with a unique unit identification number and each of the at least one siren module and at least one light module store a unique identification number in memory, the remote control including an infrared configuration port for communication with communication ports of respective at least one siren module and at least one light module for changing the unique unit identification number stored within the memory of the at least one siren module and at least one light module.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a perspective view of a wireless emergency vehicle light and siren kit in accordance with the present invention.

FIG. 2 is a view of the wireless emergency vehicle light and siren kit components within a carrying case.

FIGS. 3, 4 and 5 are various views of the light module.

FIGS. 6, 7, 8 and 9 are various views of the siren module.

FIG. 10 is a perspective view of a remote control.

FIGS. 11A and 11B are perspective views of an L-shaped mounting bracket.

FIGS. 12, 13, 14, 15 and 16 are views showing installation and use of the mounting bracket shown in FIGS. 11A and 11B.

FIGS. 17 and 18 are views showing a spring hinge mounting bracket.

FIG. 19 shows an assembly variation of the light module using the spring hinge mounting bracket of FIGS. 17 and 18 and the hinged mounting bracket of FIG. 20.

FIG. 20 is a perspective view of the hinged mounting bracket.

FIG. 21 is a side view showing use of the hood in conjunction with the light module.

FIGS. 22 and 23 show alternate mounting options in accordance with the present invention.

FIG. 24 is a perspective view of the siren power cable.

FIGS. 25 and 26 show attachment of the siren power cable to the siren module and the battery.

FIG. 27 is a perspective view showing mounting of the siren module.

FIG. 28 is a back view of the remote control shown in FIG. 10.

FIG. 29 shows the remote control adjacent the light module for adding the light module to control of the remote control.

FIG. 30 is a schematic of the remote control operational buttons.

FIG. 31 is a schematic of the remote control electrical/operational system.

FIG. 32 is a schematic of the light module electrical/operational system.

FIG. 33 is a schematic of the siren module electrical/operational system.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

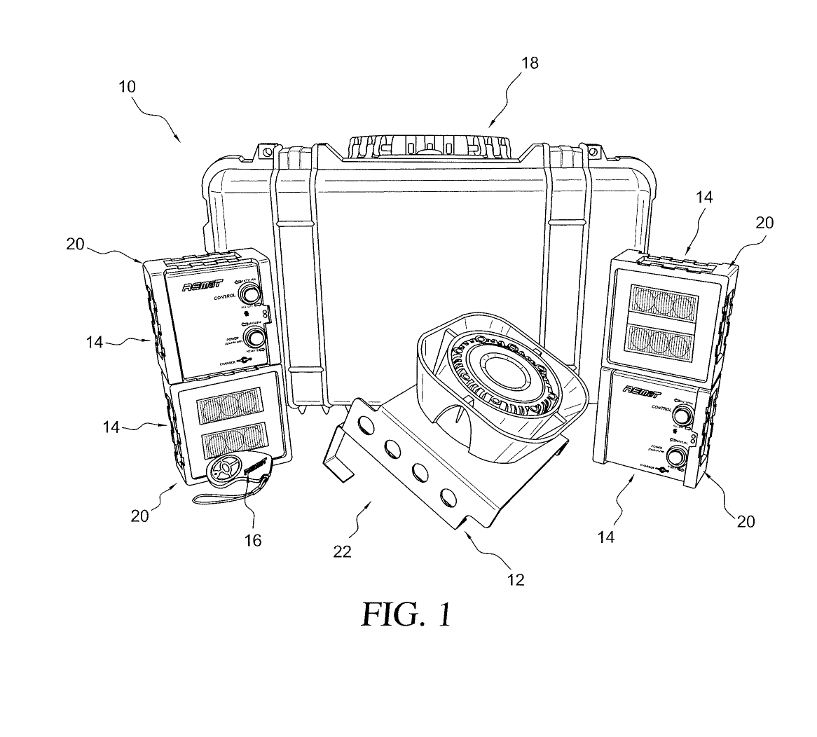

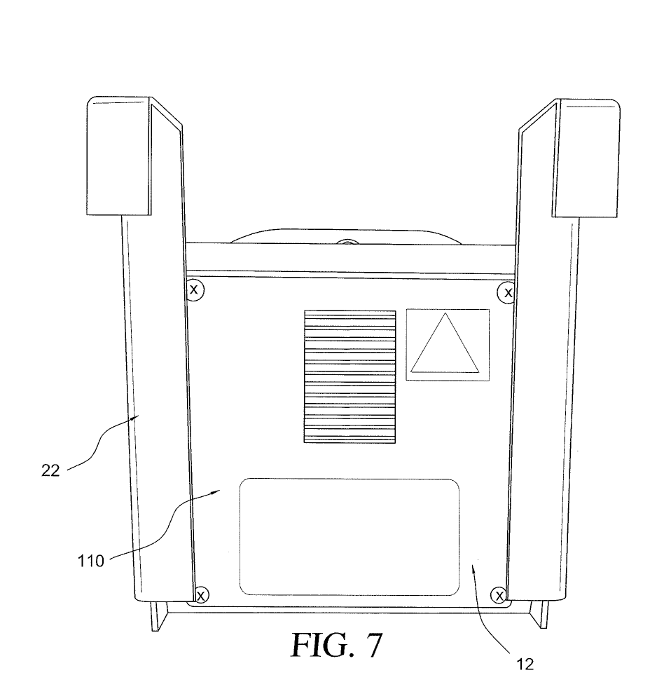

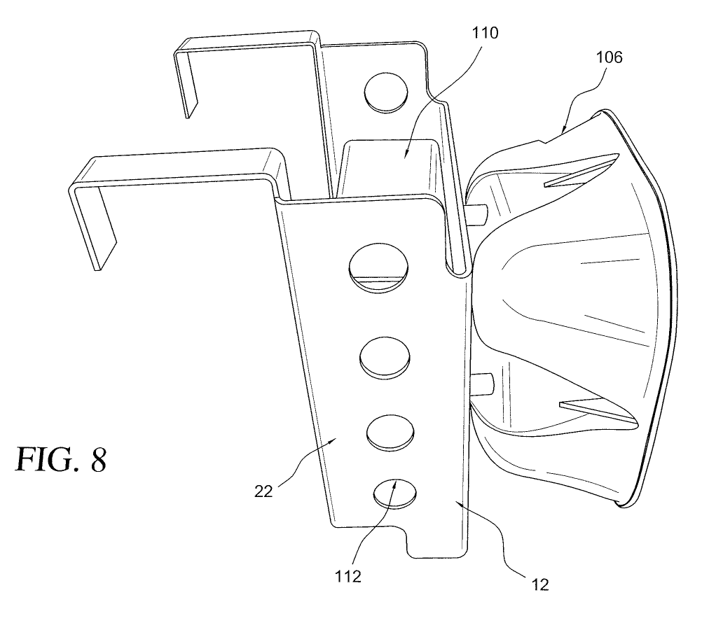

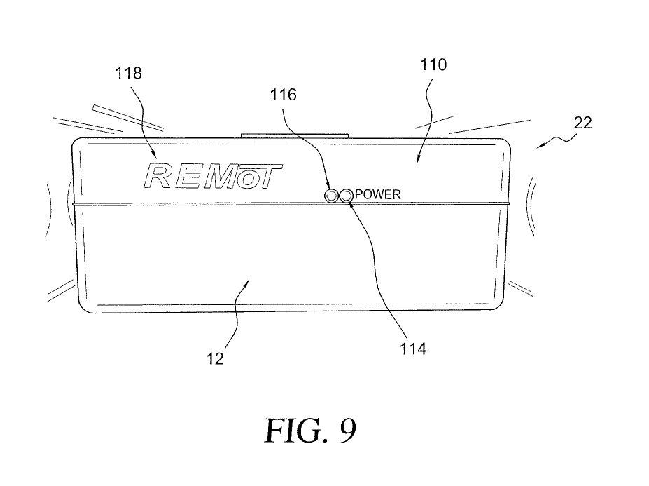

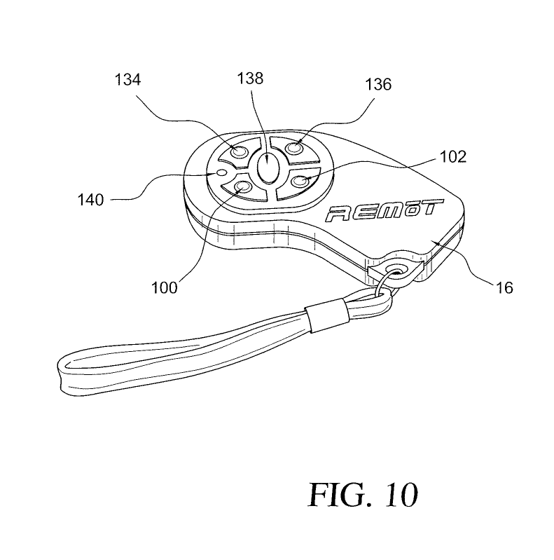

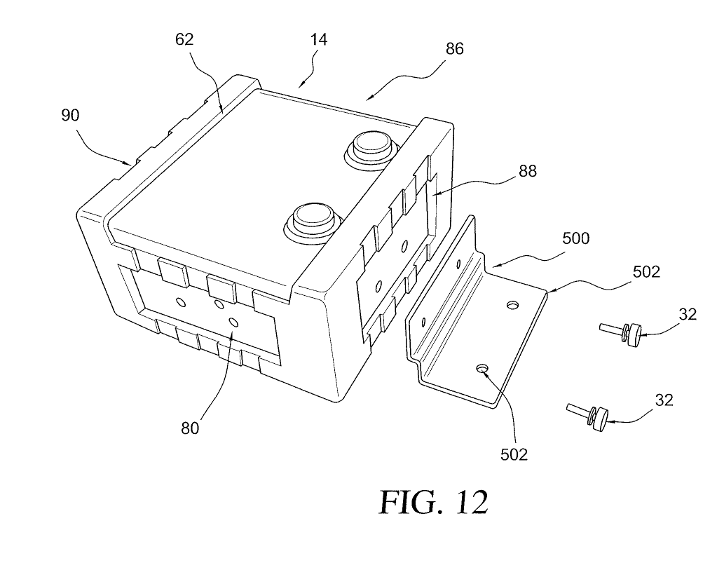

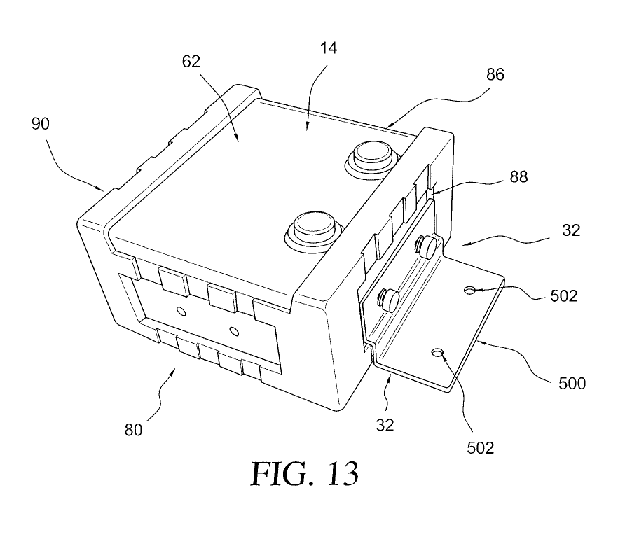

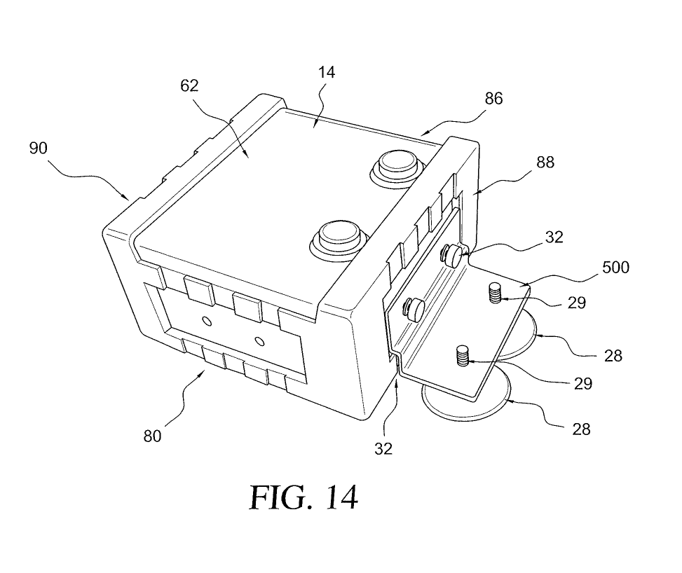

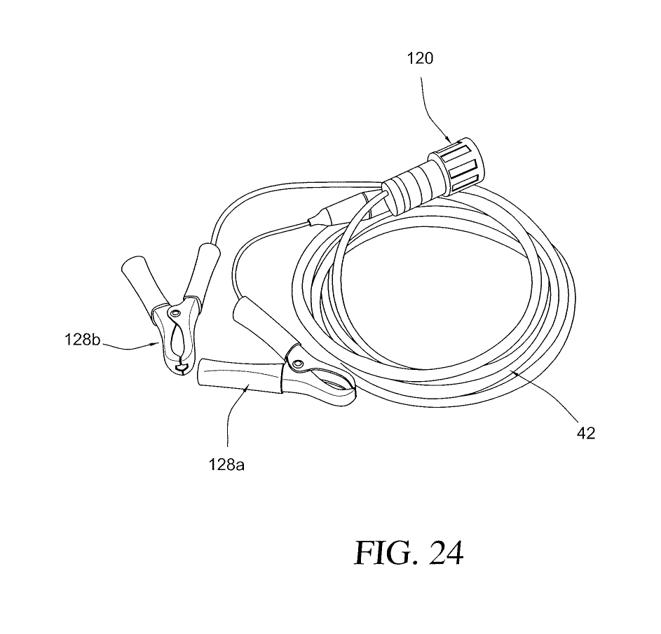

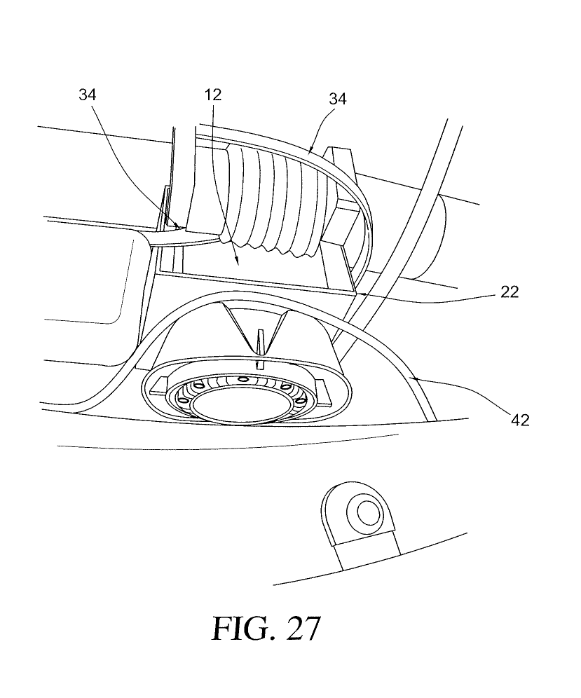

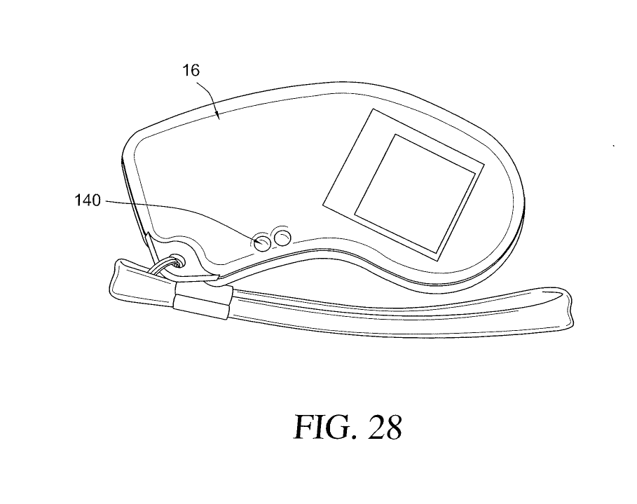

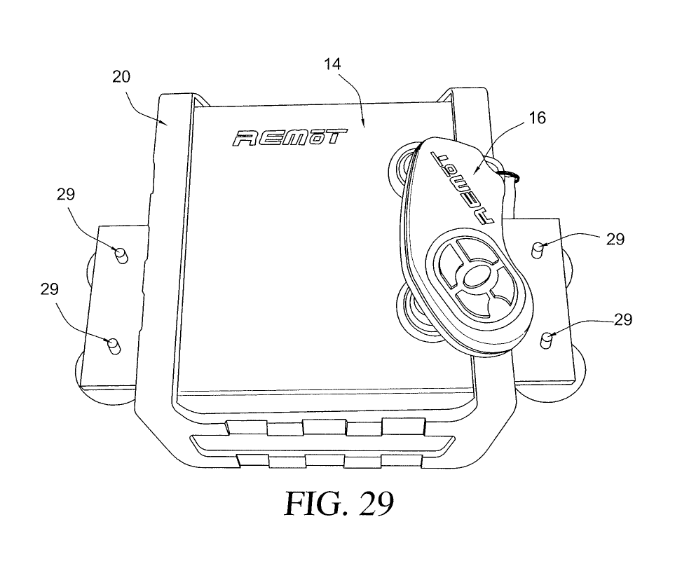

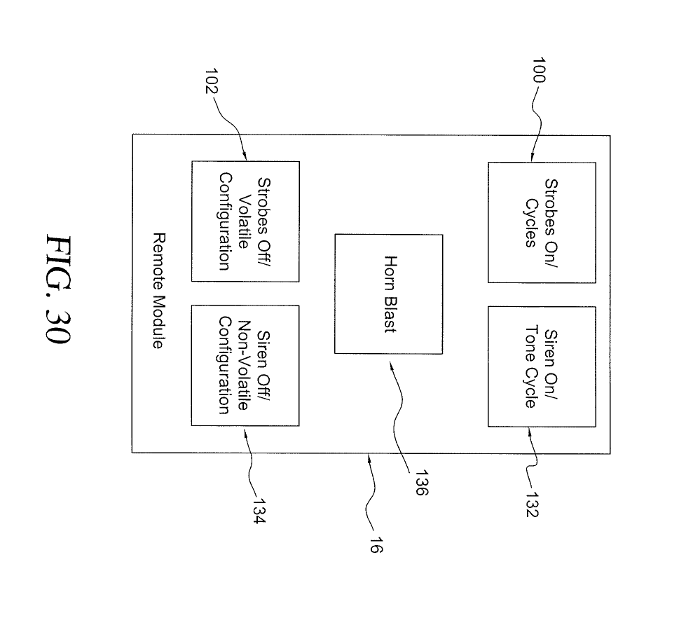

Referring to FIGS. 1 to 33, a versatile, easy to install lightweight wireless alarm system (also referred to as a wireless emergency vehicle light and siren kit) 10 that provides a safe vehicle for HRP (High Risk Personnel) and allows any vehicle to be quickly transitioned to a temporary emergency vehicle is disclosed. The alarm system 10 includes a siren module 12 and emergency light modules 14 (for example, four in accordance with a preferred embodiment) which can be powered on and off manually or via a small remote control 16. The remote control 16 is also used to cycle through available flash patterns and siren tones. The emergency light modules 14 are powered by internal rechargeable battery packs for up to 8 hours of operation. The alarm system 10 also includes a carrying case 18 shaped and dimensioned for storing equipment for charging the batteries either from AC wall power or DC vehicle power for versatility. Also included in the carrying case 18 are a variety of mounting brackets 500, 600, 700 and hardware employed in adapting the siren module 12 and light module 14 for use in a variety of installation scenarios and vehicles.

The siren and light modules 12, 14 are interchangeable for use with different component assemblies with simple reprogramming via the remote control 16. In accordance with a preferred embodiment, the carrying case 18 is an airline approved carry on container for easy transportation and is commercially available to the law enforcement community.

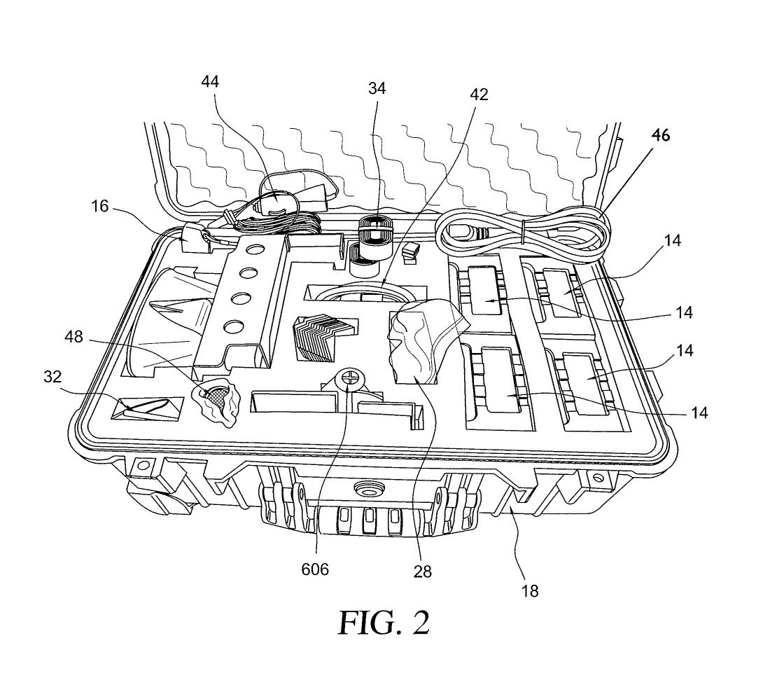

More particularly, and with reference to FIGS. 1 and 2, the alarm system, that is, the wireless emergency vehicle light and siren kit, 10 includes a plurality of light and siren modules 14, 12 employed in accordance with the present invention. Briefly, and in accordance with a preferred embodiment, the alarm system 10 includes light modules 14 with a protective boot 20, siren module(s) 12 with an integral mounting bracket 22, and a remote control 16 in the form of a key fob.

The alarm system 10 also includes mounting hardware for assembly and secure mounting of the various components in a manner that will be better appreciated based upon the following disclosure regarding the use and assembly of the present alarm system 10. The mounting hardware includes a spring hinge windshield bracket 600, right angle/suction cup brackets 500, suction cups 28 (screw in, adjustable), a hinge bracket 700, thumb screws 32, nylon straps 34 (for securing the siren module 12 under hood), and carabiner 36 (for use as an anchor point with the nylon straps 34).

In addition to the mounting hardware, various accessories are provided enhancing the functionality of the present system 10. These accessories includes a battery charger wall adapter 38 (built into the carrying case 18); a 1 to 4 power distribution charging jack harness 40 (built into the carrying case 18); a vehicle battery to siren power cable 42; a cigarette lighter adapter 44, a charging cable 46 (for DC charging); a led flashlight 48 (aluminum, water resistant); an instruction guide/operator's manual 50; a quick start guide 52; an anti-reflection collar 54 (for dash mounted light modules, optional); and a bag containing 1 spare remote control battery 56, 1 spare siren module fuse (10a) 58, 1 spare light module charging fuse (2A) 60.

Referring now to FIG. 1, a plurality of identical light modules 14 are disclosed and it should be understood that although only one is disclosed herein, each of the other light modules 14 is the same. The light module 14 is a battery powered, remotely controlled, emergency warning light source. It is capable of multiple light flash patterns, selectable by the user. The light module 14 can be operated in either an automatic remote mode or a manual mode as desired and explained below in greater detail.

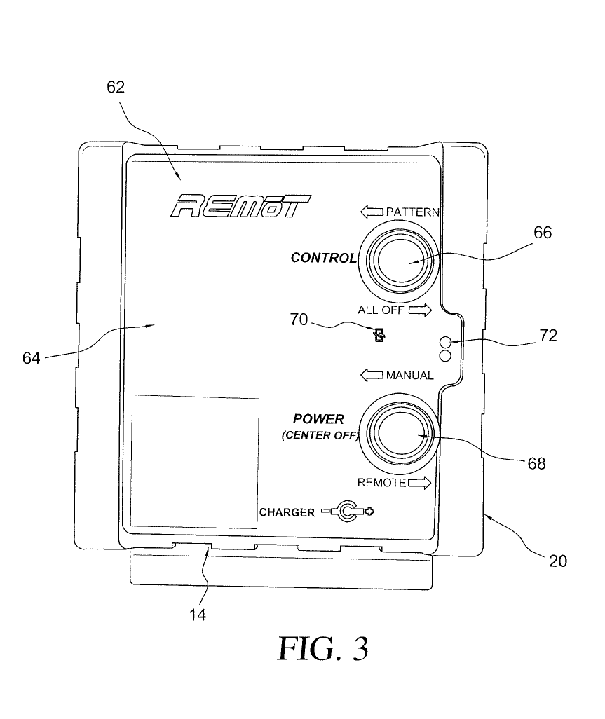

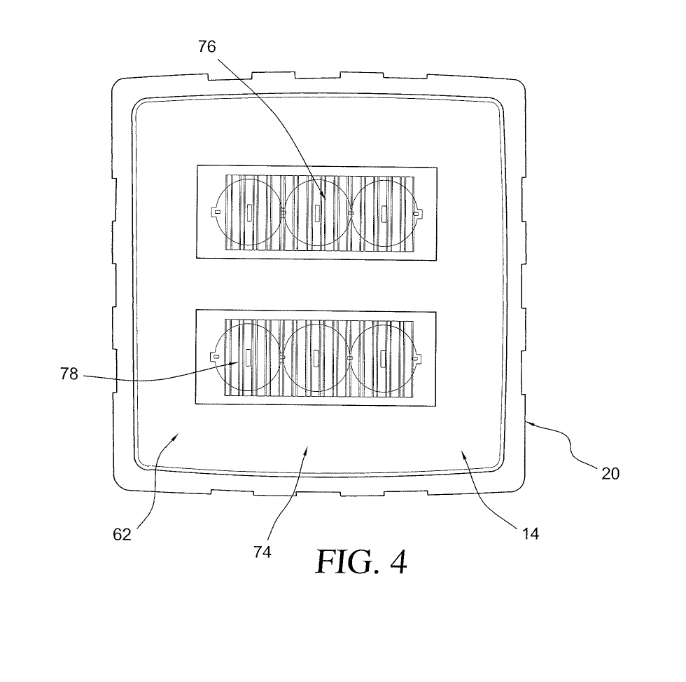

Referring now to FIGS. 3, 4 and 5, the light module 14 includes a housing 62 in which various functional and control components of the light module 14 are housed. Referring to the rear wall 64 of the light module 14 as shown with reference to FIG. 3, the light module 14 is provided with a flash pattern & all off control 66, a power/mode switch 68, a battery symbol status indicator 70 and infrared configuration ports 72. Now turning to the front wall 74 of the light module 14 as shown with reference to FIG. 4, the light module 14 includes a red first super bright LED light module 76 and a blue second super bright LED light module 78. The first and second super bright LED light modules 76, 78 are covered and protected by a protective boot 20 secured to and covering the housing 62 of the light module 14.

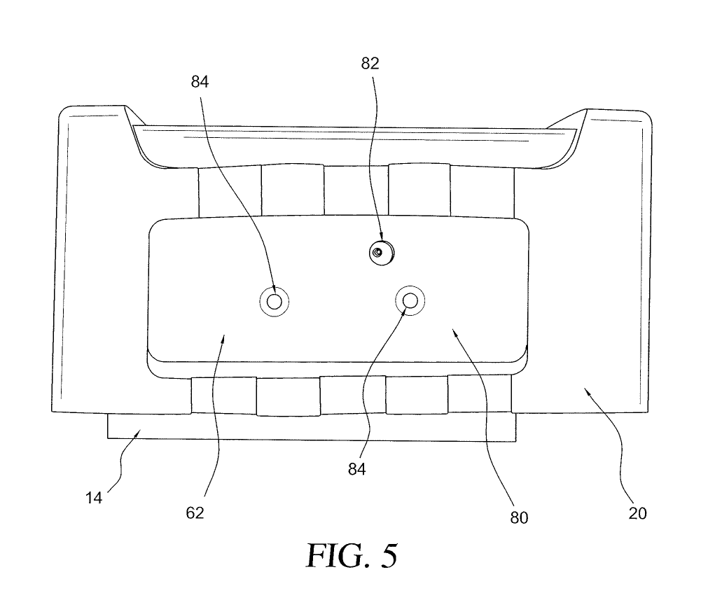

Referring now to FIG. 5, the bottom side wall 80 of the housing 62 of the light module 14 is shown. The bottom side wall 80 is provided with a battery charger connection jack 82 and threaded inserts 84 for receiving thumb screws 32 used in securing mounting brackets 500, 600, 700 to the side walls of the housing 62 of the light module 14 in the manner discussed below in greater detail. The top side wall 86 and lateral side walls 88, 90 are similarly provided with threaded inserts 84 shaped and dimensioned for receiving thumb screws 32 used in securing mounting brackets 500, 600, 700 to the various side walls of the housing 62.

As briefly discussed above, the present alarm system 10 is supplied with a variety of mounting brackets 500, 600, 700 that can be mixed and matched in order to adapt the light modules 14 for mounting in a wide range of vehicles and at a variety of locations. As a user becomes more familiar with the operation and possible uses of the present system, devising the correct combination of mounting brackets 500, 600, 700 for a particular type of vehicle will become easier. The mounting brackets 500, 600, 700 can be mounted to any side of the light module 14 using the supplied thumb screws 32 without the need for tools.

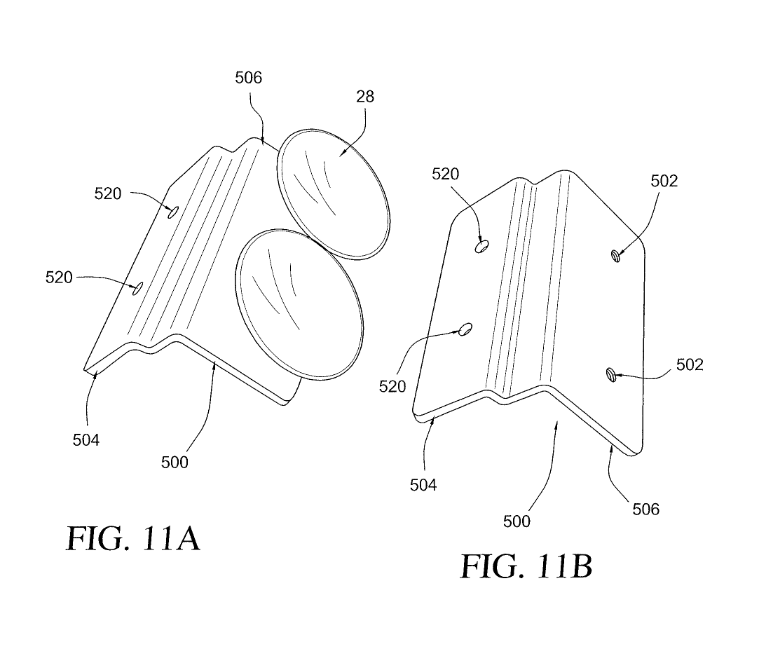

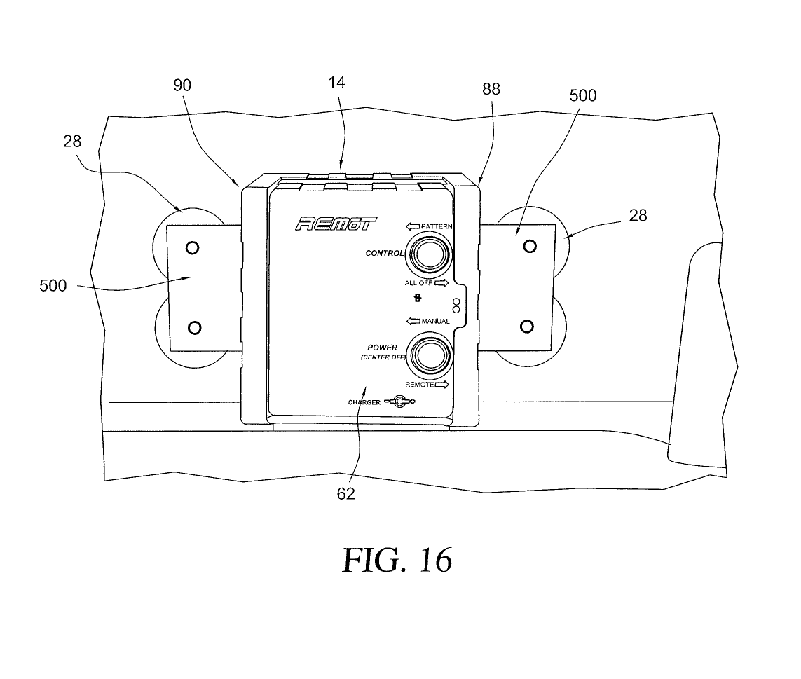

In accordance with a first embodiment, and with reference to FIGS. 11A, 11B, 12, 13, 14, 15 and 16, the light module 14 is assembled by attaching mounting brackets 500 thereto. More particularly, the mounting bracket 500 is an L-shaped, right angle mounting bracket that may be mounted on any side of the light module 14 using the supplied thumb screws 32. The mounting bracket 500 includes a planar first bracket member 504 rigidly secured at approximately a right angle to a planar second bracket member 506. The first bracket member 506 is shaped and dimensioned for attachment to the light module 14 via thumb screws 32 and includes connection apertures formed therein 520. The second bracket member 506 is shaped and dimensioned for coupling with suction cups 28 for attachment to the vehicle as shown with reference to FIG. 16 and includes threaded apertures 502 for receiving the threaded posts 29 of the suction cups 28.

Up to four (4) mounting brackets 500 may be secured to any one light module 14. Although as discussed below this mounting bracket 500 is particularly designed for use in conjunction with suction cups 28, the mounting bracket 500 may also be used without the suction cups, for applications where the mounting bracket 500 may be slid between the window glass and an internal body panel (such as at the bottom of a vehicle's side windows). Where no suction cups are used on a mounting bracket 500 in such an arrangement, it is recommended this type of mounting be supplemented through the use of at least one other angle mounting bracket (discussed below) utilizing the suction cups 28 for stability. More mounting brackets 500 with suction cups 28 may be used for mounting to vertical windows such as the back glass of a SUV if planning to mount toward the top of the glass for added visibility.

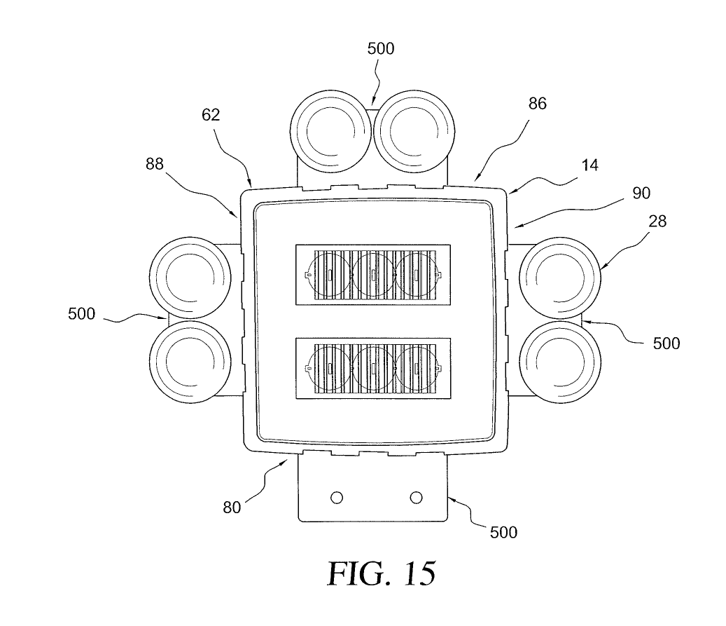

As discussed above, the mounting brackets 500 are attached to the light module 14 using thumb screws 32 shaped and dimensioned for engagement with the threaded apertures 84 formed in the side walls 80, 86, 88, 90 of the housing 62 of the light module 14. The suction cups 28 are attached to the mounting brackets 500 via threaded posts 29 shaped and dimensioned for attachment to threaded holes 502 formed at predetermined locations along the mounting brackets 500. By providing a threaded engagement between the mounting bracket 500 and the suction cup(s) 28, the operator is able to adjust the relative position of the suction cup 28 by simply rotating the suction cup 28 relative to the mounting bracket 500 upon which it is mounted. In accordance with a preferred embodiment, a possible mounting bracket 500 and suction cup 28 configuration is shown with reference to FIG. 15. This configuration employs first, second and third mounting brackets 500 secured along the side walls 80, 86, 88, 90 of the housing 62 for the light module 14. Each of the first, second and third mounting brackets 500 is provided with a pair of downwardly facing suction cups 28 secured via threaded post 29 engaging the mating threaded holes 502 formed in the mounting bracket 500.

With the mounting brackets 500 and suction cups 28 secured to the light module 14, the light module 14 may be applied to a variety of desired support surfaces in a variety of orientations depending upon the needs of the user. For example, and with reference to FIG. 16, the light module 14 may be mounted to a vehicle window.

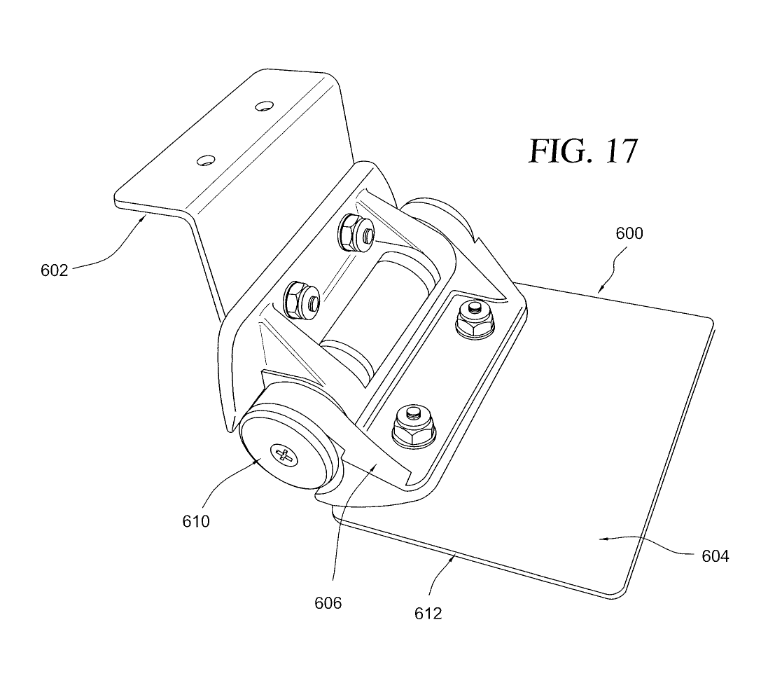

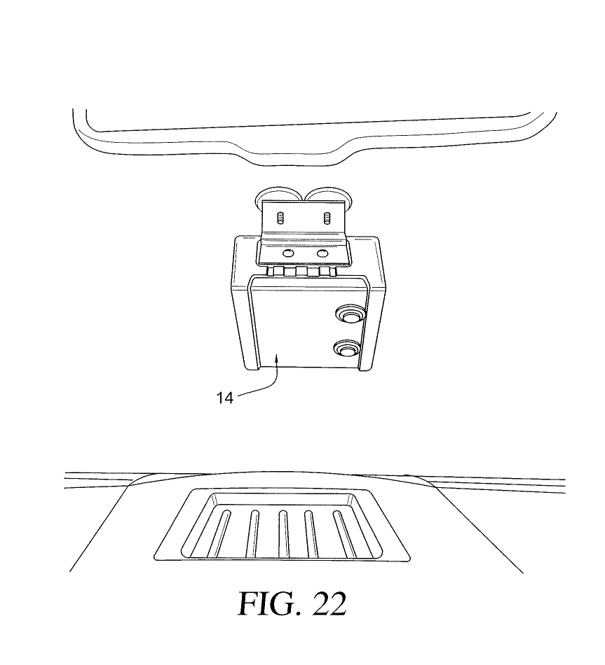

Referring to FIGS. 17, 18, 19 and 22, an alternate mounting bracket 600 is disclosed. The alternate mounting bracket 600 allows for pivotal adjustment of the light module 14. In particular, the mounting bracket 600 includes a planar first bracket member 602 pivotally secured to a planar second bracket member 604. The first bracket member 602 is shaped and dimensioned for attachment to the light module 14 via thumb screws 32 in a manner similar to the mounting brackets 500 discussed above with regard to FIGS. 11A, 11B, 12, 13, 14, 15 and 16. The second bracket member 604 is shaped and dimensioned for attachment to a mating mounting structure secured to the vehicle as shown with reference to FIG. 22.

The pivot employed in accordance with a preferred embodiment of the present invention is spring hinge 606. The spring hinge 606 allows for relative movement between light module 14 and the second bracket member 604 but will bias the light module 14 back to its desired orientation after the pressure causing movement of the light module 14 is released.

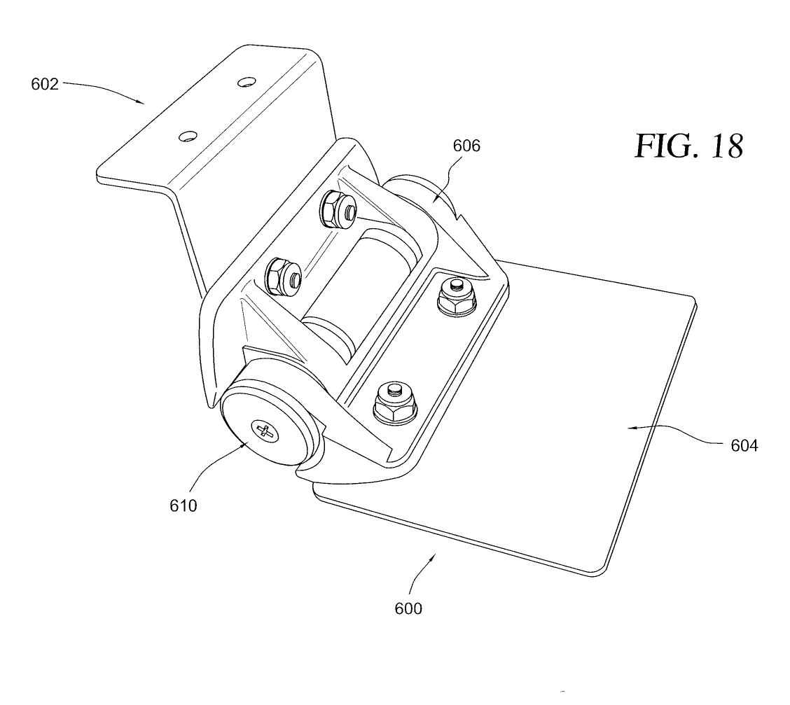

The spring hinge mounting bracket 600 was designed for use, primarily, on the front windshield of vehicles, but may also have applications on vehicles with rear shelves. The spring hinge 606 provides an upward pressure on the light module 14 while allowing the base (or second bracket member) 604 to adapt to different dash angles. If desired, more tension can be applied by adjusting the spring hinge 606. This is accomplished by using a Phillips head screw driver to remove the end cap (not shown) of the hinge 606 (See FIGS. 17 and 18). If the user desires more tension, a flat blade screwdriver is used to push in and rotate the adjustment knob 610 toward the plus (+). The adjustment knob 610 is rotated toward the minus (−) if less tension is desired. The base plate 604 of this mounting bracket 600 is supplied with a highly tacky, anti-slip pad 612 to help keep the mounting bracket 600 in place. This pad 612 should be kept clean and free of dust, dirt or other debris that could reduce its effectiveness.

If the windshield is relatively flat and vertical, the spring hinge mounting bracket 600 may be combined with one or two suction cup mounting brackets 500 as discussed above with reference to FIGS. 11A, 11B, 12, 13, 14, 15 and 16 for a secure mount.

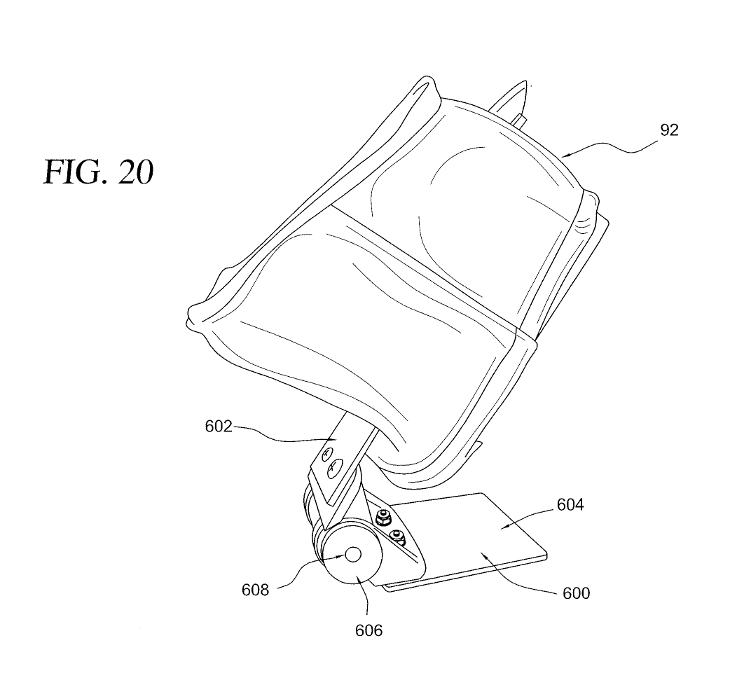

In the event that the windshield is more angled, it may be more desirable to have the light module 14 oriented in a more vertical position to allow for optimum visibility. For applications such as these, the user may combine the spring hinge mounting bracket 600 with the flex hinge mounting bracket 700 with suction cups 28 installed (discussed below with reference to FIG. 20). By placing the flex hinge mounting bracket 700 on the top of the light module 14 opposite the spring hinge mounting bracket 600, the user may orient the light module 14 in a more vertical position. The spring hinge 606 provides the upward pressure with base stability and the flex hinge mounting bracket 700 ensures the light module 14 is firmly attached to the windshield by adapting to the windshield angle.

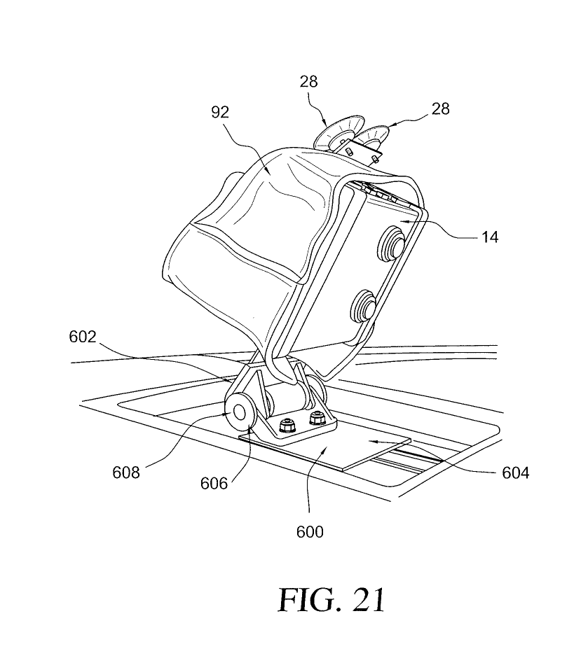

It should be appreciated that in order to reduce the effects of reflective flash back into the passenger compartment when the light module 14 is mounted on the dash of a visible, the provided flash reduction hood 92 may be fitted around the dash mounted light module 14, as shown in FIG. 21, below. Use of this hood 92 does, however, reduce the effective viewing angle of the light module 14. Additionally, and due to varying windshield angles, the hood 92 may not completely block flash back in some applications. For those applications, it is recommended that the alternate mounting method, described below, be used.

If desired, a light module 14 may be mounted on the windshield using only the right angle brackets 500 fitted with suction cups 28 similar to mounting on vehicle side window glass (see FIG. 16). A minimum of two right angle brackets 500 should be attached if using this method. When mounting the light module 14 in this manner, the user adjusts the suction cups so that the rubber lip of the protective boot 20 just contacts the windshield glass. This will ensure a good fit. This is the recommended method of attachment for optimal viewing angle and minimal flash back into the passenger compartment. This type of bracket configuration may be also be used for the rear window of automobiles with angled rear glass and a rear shelf area.

Another mounting bracket 700 is disclosed with reference to FIG. 20. The flex hinge/suction cup mounting bracket 700 was designed to allow light modules 14 to be mounted in a more vertical orientation in applications where the front windshield of vehicles is angle sharply back. When equipped with suction cups 28, this mounting bracket 700 attaches to the top of the light module 14. The flex hinge mounting bracket 700 works in conjunction with the spring hinge mounting bracket 600 to provide a firm front mount for the light module 14 while providing optimum light visibility.

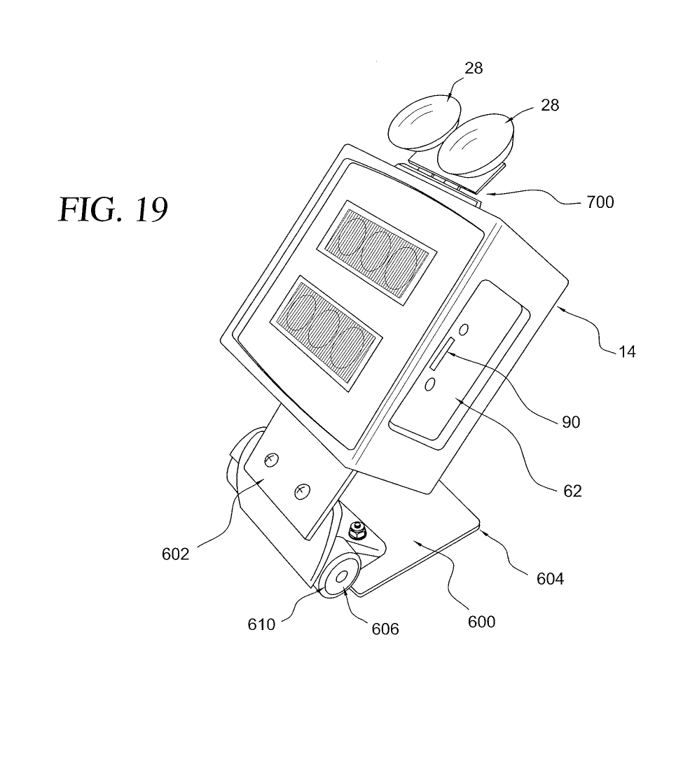

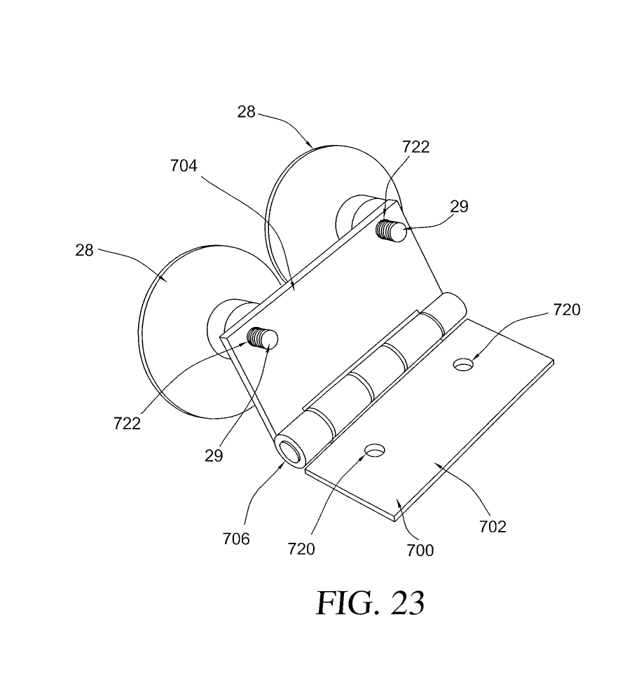

As with the mounting bracket 600 shown with reference to FIGS. 17 and 18, the mounting bracket 700 includes a planar first bracket member 702 pivotally secured to a planar second bracket member 704. The first bracket member 702 is shaped and dimensioned for attachment to the light module 14 via thumb screws 32 in a manner similar to the brackets 500, 700 discussed above and includes connection apertures formed therein 720. The second bracket member 704 is shaped and dimensioned for coupling with suction cups 28 for attachment to the vehicle as shown with reference to FIGS. 19 and 23 and includes threaded apertures 722 for receiving the threaded posts 29 of the suction cups 28.

The pivoting hinge 706 employed in accordance with a preferred embodiment of the present invention is a freely pivoting hinge. The hinge 706 allows for relative movement between light module 14 and the second bracket member 704.

With the following discussion regarding operation in mind, it should first be appreciated each light module 14 is provided with a light module power/mode switch 68 (which is a maintained switch) and a light module pattern/all off switch 66 (which is a momentary switch). Each of these switches are single pole/double throw switches allowing each switch to control two functions by either left actuation or right actuation. In use, in particular, for manual operation, the light module power/mode switch 68 is set to manual by left actuation (that is, pressing the left side 68a of the light module power/mode switch 68). With the module power/mode switch 68 set to manual, the first and second super bright LED light modules 76, 78 will activate. If the user wishes to change the flash pattern, he or she will press the left side 66a of the light module pattern/all off switch 66. It should be noted the remote control 16 does not function in manual mode. It should also be noted that each siren and/or light module 12, 14 operates independently.

Where a user desires remote operations, the user sets the light module power/mode switch 68 to remote by pressing the right side 68b of the light module power/mode switch 68. The first and second super bright LED light modules 76, 78 of the light module 14 will not activate until the lights On button 100 is pressed on the remote control 16. To change the flash pattern, the user presses the lights On button 100 on the remote control 16 to cycle through flash patterns. To stop the flashing lights, the user presses the lights Off button 102 on the remote control 16 or presses and holds the ALL OFF switch 68a (that is, pressing the left side 68a of the light module pattern/all of switch 66) on any light module 14 within the wireless emergency vehicle light and siren kit to stop all light and siren modules 14, 12 in a kit. It should be appreciated the power/mode switch 68 on each light module 14 must be placed in the OFF position (by ensuring neither left side 68a nor the right side 68b of the power/mode switch 68 are pressed down) when not in use; otherwise the light modules 14 are in standby awaiting a remote operation command. The pattern select switch (left side 66a of the pattern/all off switch 66) also works in remote mode; however it only affects that light module 14.

More particularly, when it is desired to operate the light module 14 in manual mode, the power/mode switch 68 is placed in the manual position (that is, the left side 68a of the power/mode switch 68 is pressed down). The lights of the light module 14 will power up with the default flash pattern. This default flash pattern has been optimized to provide maximum run time under battery power. If desired, the flash pattern can be changed to one of 5 other patterns by simply pressing the pattern select switch 66a of the pattern/all of switch 66 on the back of the light module 14 to step through the available flash patterns. To power down the light module 14, the power/mode switch 68 is placed in its center or OFF position. As discussed above, it should be appreciated the ALL OFF switch 66b does not function in manual mode.

When the user desires to operate the light module 14 in automatic/remote mode, the power/mode switch 68 is first placed in the auto position by pressing the right side 68b of power mode switch 68 down. This will power up the light module 14 internal electronics, but the flashing lights will not activate. The lights on/pattern select button 100 on the remote control 16 is then pressed. The lights will power up in the default flash pattern. Pressing the lights on/pattern select button 100 again will advance the light module 14 to the next flash pattern. Each press of the lights on/pattern select button 100 will advance one pattern cycling back to the default. It should be noted the pattern switch 66a of the pattern/all off switch 66 on the back of each light module 14 may also be used to change flash patterns, but only for that one light module 14.

It is also possible to synchronize flash patterns. Due to varying light module 14 locations and command delays, it is possible to have light modules that flash different patterns within the same group of light modules 14 mounted upon a vehicle (or other support surface). To keep light modules 14 synchronized, it is recommended to leave the light modules 14 on the default flash pattern or when making pattern changes via the remote control 16, press the lights on/pattern select button 100 and then wait a couple of seconds to allow the light modules 14 to receive the command and sync the flash patterns. Since the normal mounting configuration is one light module 14 per side of the vehicle, varying flash pattern may not be an issue; however, the above procedure will assist in keeping the patterns between modules matched.

The first and second super bright LED light modules 76, 78 of the light module 14 may be disabled at any time, by pressing the lights off/temporary configuration button 102 on the remote control 16. This action only turns off the flashing lights. The internal electronics continue to operate, waiting for the next remote control 16 command. An alternative to this procedure is to use the ALL OFF switch 66b as discussed herein in greater detail.

In a situation where the remote control 16 cannot be used to power off the light module(s) 14, the present system 10 is capable of implementing an emergency “ALL OFF” command override that will disable all the light and siren modules 14, 12 in a particular wireless emergency vehicle light and siren kit. This is achieved by simply pressing and holding the “ALL OFF” switch 66b on any light module 14 in the group and the light modules 14 and siren module 12 will be disabled. It should be appreciated that disabling light and siren modules 14, 12 does not power them down completely as the internal control electronics are in a standby state awaiting the next remote control 16 command. To power the light modules 14 off, place the power/mode switch 68 to the center (OFF) position.

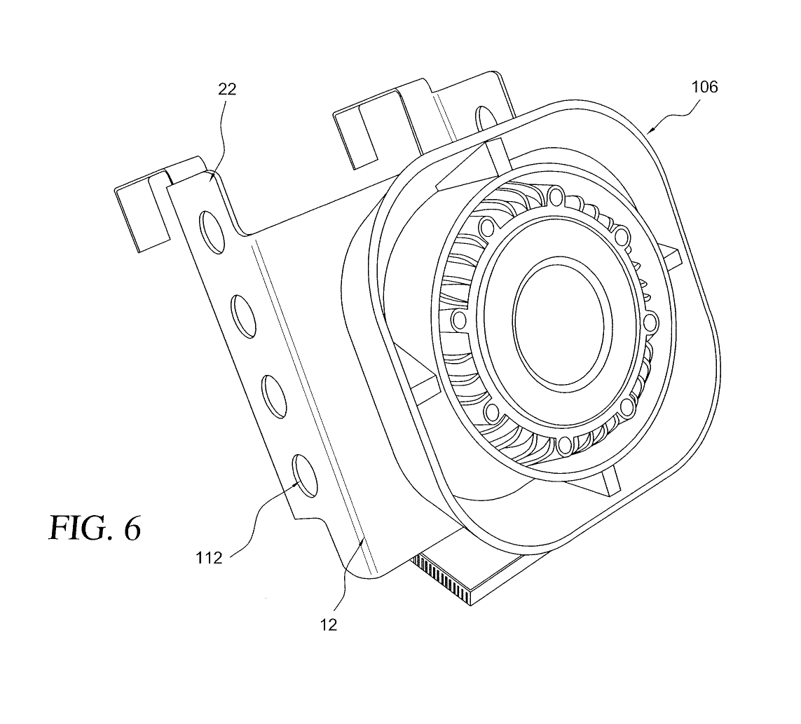

Turning now to the siren module 12, and as shown with reference to FIGS. 6, 7, 8, 9, 24, 25, 26 and 27, the siren module 12 is a remotely controllable, emergency audible warning device. It is capable of outputting 4 different siren tone patterns, individually selectable by the user. The siren module 12 is also equipped with a horn blast feature, useful to call attention to the vehicle in special situations such as clearing an intersection. The siren module 12 can only be operated in automatic remote mode, by design, to help prevent long term, permanent hearing damage through accidental exposure to sound levels exceeding 120 db.

The siren module 12 includes a conventional siren speaker horn 106 mounted upon a mounting bracket 22. Secured to the mounting bracket 22, and integrally associated with the siren speaker horn 106, is an amplifier thermal management system 110.

The mounting bracket 22 is formed with mounting strap holes 112. The mounting strap holes 112 are shaped and dimensioned for receiving straps 34 used in securing the siren module 12 to a vehicle in a manner discussed below in greater detail. The siren module 12 is also provided with a power indicator 114 and infrared configuration ports 116 along the top side wall 118 thereof.

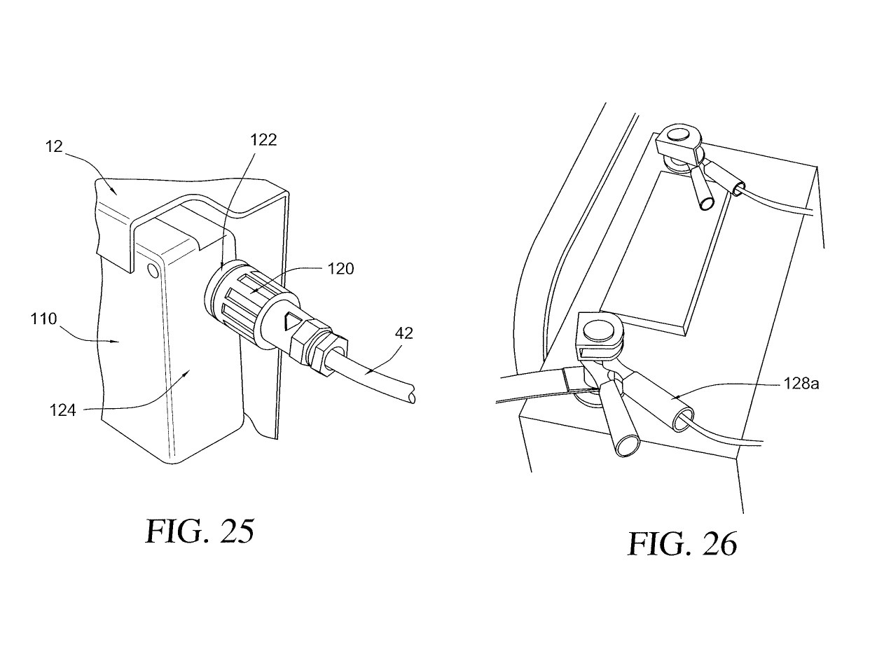

The siren module 12 is mounted in the following manner. The connectors 120 of the siren power cable 42 are attached to the mating connector 122 on the bottom 124 of siren module 12 (See FIG. 25). The user then chooses a space under the vehicle hood large enough to safely place the siren module 12 so that the speaker is not blocked. This could be either in front of or behind the radiator. The user then selects a location away from rotating or moving engine components. The selected location must also be away from extreme heat generating engine components such as the exhaust manifold. Where possible, the bracket hooks should be used to support the weight of the siren module 12. Always use at least one nylon safety strap 34 routed through the strap holes 112 on the mounting bracket 22 to secure the siren module 12. If necessary, utilize the included carabineer 36 as an anchor point for attachment of the nylon strap 34 to the vehicle.

The operator then ensures that the siren module 12 is secure and cannot move or swing into the vehicle radiator or any moving engine components, or otherwise interfere with the safe operation of the vehicle. The siren modules 12 should never be activated while in the process of mounting it as severe hearing damage may occur. Once the siren module 12 is securely mounted, the battery clamps are carefully attached to the vehicle battery. The operator should then ensure the siren power cable 42 is routed away from moving or rotating engine components and take care to not catch the siren power cable 42 in the vehicle hood or hood hinges.

More particularly, and in accordance with a preferred embodiment of the present invention, the siren module 12 has an integral mounting bracket 22 that is patterned after the permanent mounting bracket that comes standard with a commercial siren speakers. This type of mounting bracket 22 is intended for mounting the siren module 12 between the vehicle radiator and grille, hanging the unit on the radiator guard, such as in a Chevrolet Suburban. This type of mounting, however, may not be possible in other makes or models of vehicles. Therefore, users will need to locate an area under the vehicle hood that is large enough to accommodate the siren module 12, but located well away from rotating or moving components under the hood. Also, for best results, orient the siren speaker horn 106 so that it is not obstructed. This may be more difficult in smaller vehicles, due to space constraints under the hood.

In order to help secure the siren module 12 in areas where hanging it by the integral bracket is not feasible, two durable nylon straps 34, with nylon quick release buckles, are provided to help secure the siren module 12 in place. The integral mounting bracket 22 has several strap holes 112 on either side that will allow the straps 34 to be threaded through and mounted to just about any, under hood, cross member, surface. To give even more mounting flexibility, the straps 34 may be used in combination with the provided carabineer 36 clip hook to mount the siren module 12 securely under the hood. It is recommended, however, that the siren module 12 be mounted away from moving components in the engine compartment as well as away from exhaust components. Extreme heat may damage or compromise the operation of the siren module 12.

Once the siren module 12 is securely mounted, the siren power cable 42 can then be routed to the vehicle battery. The siren power cable 42 has a circular, keyed connector 120 for attaching to the siren module 12, on one end and two battery cable clamps 128a, 128b and fuse holder on the other. The battery cable clamps 128a, 128b may be attached to the two battery terminals, attaching the Red clamp to the Positive (+) terminal and the Black clamp to the Negative (−) terminal, in much the same way as attaching jumper cables. When replacing a fuse, use only 5×20 mm, 10 A, fast blow fuses. It should also be noted the user should be careful to route the siren module 12 Power Cable away from belts, pulleys, fans and any moving or rotating components under the hood.

To activate the siren module 12, the siren module 12 is simply mounted and secured in the desired location on the vehicle. The siren module 12 is connected to the vehicle battery using the included siren power cable 42, connecting the Red clamp 128a to the positive (+) battery terminal and the black clamp 128b to the negative (−) battery terminal. The internal electronics will be activated and ready to receive an operation signal from the remote control 16 once the power cable is connected to the siren module 12 and to the vehicle battery.

A status indicator 114 will illuminate the POWER symbol to indicate that the system 10 is connected to a power source. When the POWER symbol is illuminated, the siren module 12 is powered, active and ready to receive a command from the remote control 16.

For safety reasons the siren module 12 does not have a manual mode of operation. Once connected to the vehicle battery, the siren module 12 is active and awaiting a signal from the remote control 16. To activate siren tones, press the siren On pushbutton 132 on the remote control 16. The siren tone will begin playing. To change the siren tone, press the siren On/tone select button 132 to cycle through the 4 preprogrammed tones. To deactivate the siren module 12, press the siren Off pushbutton 134. This places the siren module 12 in standby mode; that is the siren module 12 is still on, but in standby awaiting a command from the remote control 16. To activate the horn blast function, press the horn pushbutton 136 on the remote control 16. The horn blast will sound interrupting the siren tone and then resume once the horn blast button 136 is released. The horn blast will also sound if the siren tones are deactivated.

It should be appreciated the ALL OFF command from the light modules 14 will also deactivate the siren tone, but does not turn the module off. To turn the siren module 12 off, disconnect the siren power cable 42 from the vehicle battery.

More particularly, the siren module 12 operates only in automatic mode via the remote control 16. This provides safety for the user. The siren module 12 is capable of producing hearing damaging sound levels and therefore cannot be activated via a switch or button on the siren module 12 itself. This helps prevent unnecessary user exposure to damaging sound levels. Connecting the siren module 12 to the vehicle battery turns on the internal control electronics, which will not activate the siren module until receiving a signal from the kit remote control 16. This allows the user to install the siren module 12 in a secure, remote location and then activate it once safely inside the vehicle or at a safe distance from the siren module 12.

To activate the siren module 12, the user presses the siren On/tone select button 132 on the remote control 16 unit. The default tone should sound. To change the siren tone, the user simply presses the siren On/tone select button 132 on the remote control 16 again. Each press of the siren On/tone select button 132 advances through the 4 available tones.

To engage the horn blast function, the user simply presses the horn blast button 136 on the remote control 16 at any time. The horn blast overrides the current siren tone when activated.

To deactivate the siren tone, the user presses the siren Off/permanent configuration button 134 on the remote control 16. This will only deactivate the siren tone as the internal electronics are still active and awaiting a signal from the remote. An alternative to this procedure is to use the ALL OFF switch 66b of the light module 14.

In a situation where the remote control 16 cannot be used to power off the siren module 12. The system 10 is capable of implementing an emergency ALL OFF command override that will disable all the light and siren modules 14, 12 in a particular kit. This is achieved by simply pressing and holding the ALL OFF switch 66b on any light module 14 in the group and the light modules 14 and siren modules 12 will be disabled.

It should be noted that disabling light and siren modules 14, 12 does not power them down completely as the internal control electronics are in a standby state awaiting the next remote control 16 command. To completely turn off power to the siren module 12, the user must remove the siren power cable 42 connections from the vehicle battery, being careful to not short the vehicle battery.

As briefly referenced above, the remote control 16 operates all components of the present system 10. The remote control 16 includes various buttons for controlling operation of the present modules. As will be discussed below in greater detail, these buttons includes a lights ON/pattern select button 100, a lights OFF/temporary configuration button 102, a siren ON/tone select button 132, a siren OFF/permanent configuration button 134, a horn blast button 136, and an operation LED 138. Along the back surface of the remote control 16, the remote control 16 is provided with infrared configuration ports 140.

The lights on/pattern select button 100 activates the flashing first and second super bright LED light modules 76, 78 of the light module 14 when a light module 14 is in remote (automatic) mode. Once flashing lights are on, pressing the lights on/pattern select button 100 again cycles through the various flash patterns.

The lights off/temporary configuration button 102 deactivates only the flashing first and second super bright LED light modules 76, 78 of the light module 14. The light module 14 electronics are still active and waiting on a command from the remote control 16. The lights off/temporary configuration button 102 is also used for reprogramming light and siren modules 14, 12 to temporarily operate with a particular remote control 16 as will be discussed below in greater detail.

The siren on/tone select button 132 activates the siren module 12 tone. Once the siren is outputting a tone, pressing the siren On/tone select button 132 again cycles through the other siren tones.

The siren Off/permanent configuration button 134 deactivates the siren module 12 tone. The siren module 12 electronics are still active and waiting on a command from the remote control 16. The siren Off/permanent configuration button 134 is also used for reprogramming light and siren modules 14, 12 to permanently operate with a particular remote control 16 as discussed below in greater detail. This is useful when replacing a lost remote control unit.

The horn blast button 136 activates the horn blast. Pressing this horn blast button 136 will activate the horn blast function of the siren module 12 resulting in a short horn burst which will be heard in place of the current siren tone being broadcast. After the horn blast, the siren tone will resume. This function can be activated at any time. Pressing the horn blast button 136 and holding it will result in a long continuous horn blast until the horn blast button 136 is released or 1 minute.

The status, or operation, LED 138 indicates that the remote control 16 is operating and broadcasting a command. If the remote control 16 appears to not be functioning and/or the green LED is not illuminating, it is likely that battery replacement is necessary. Refer to the battery replacement section of this manual for a step by step procedure for battery replacement.

The remote control 16 is programmed using an IrDA (Infrared Data Association) program configuration. The remote control 16 comes pre-configured to operate the 4 light modules 12 and single siren module 12 that comes with it. However, there may be occasions when it is desired to add additional light modules 14 or siren modules 12 to a particular installation or application. As described above a basic wireless emergency vehicle kit in accordance with the present invention includes a siren module 12 and four light modules 14 under the control of a single remote control 16. Commands to control the strobes, that is, the first and second super bright LED light modules 76, 78, on the light modules 14 and the tone playing on the siren module 12 are sent from the remote control using an RF interface, that is, the respective RF transceivers 142, 144, 146 of the siren module 12, light module 14 and remote control 16. Each remote control 16 is associated with a unique number called a unit identification number, or KeyFobID in accordance with a preferred embodiment of the present invention, (that is, programmed such that the unit identification number is transmitted with RF commands) which allows for the selective control of siren and light modules 12, 14. Each siren and light module 12, 14 stores a KeyFobID number in a memory (formed as part of its microcontroller 148, 150) from which it will accept RF commands. An IrDA serial interface, that is, the respective IrDA transceivers 152, 154, 156 of the siren module 12, light module 14 and remote control 16, is used by a remote control 16 to program its KeyFobID into the memory of individual siren or light modules 12, 14. This IrDA configuration feature allows for siren and light modules 12, 14 to be added to or swapped between kits in the field by adding or deleting KeyFobIDs associated with different remote controls to the memories of the respective siren and light modules 12, 14.

Each remote control 16 with its unique KeyFobID forms the foundation of a wireless emergency vehicle kit in accordance with the present invention. Any combination of siren and/or light modules 12, 14 can be brought under the control of a remote control 16 by using the IrDA configuration feature.

In operation, control commands are initiated when the remote control 16 sends its KeyFobID within the transmitted RF command packets, which is then compared to the KeyFobID stored in the memory of the siren and/or light module 12, 14 receiving the packet. If the received KeyFobID does not match, the packet is ignored. Since siren and/or light modules 12, 14 can only be programmed (configured) with a single KeyFobID at any given time and each remote control 16 has a unique KeyFobID number with which it is preprogrammed, multiple kits (operating under the control of different remote controls 16) can operate within RF range of each other without interference.

The commands discussed above for controlling the siren and/or light modules 12, 14 via the remote control 16 are sent via RF communication standards. In particular, RF commands are sent by a remote control 16 to control the operation of the siren and/or light modules 12, 14 within a kit defined by a KeyFobID number. Siren and/or light modules 12, 14 retransmit any packet received that matches their KeyFobID. This retransmission feature helps to ensure that each siren and/or light module 12, 14 of a kit receives a transmitted RF packet. As discussed above, each light module 14 has an ALL OFF switch 66b, which when activated causes that light module 14 to transmit an RF “all off command”. The “all off command” causes every siren and light module 12, 14 within the same kit to either turn off the strobes or to stop playing any siren tones.

Whether the siren and/or light modules 12, 14 respond to commands issued by a remote control 16 is dictated by the unique KeyFobID associated with each remote control 16. However, the KeyFobID stored in the memory of the respective siren and/or light modules 12, 14 may be changed (either temporarily or permanently) through an IrDA configuration protocol. In particular, the IrDA serial communication interface between a remote control 16 and either a siren or light module 12, 14 is only effective if the remote control 16 and either a siren or light module 12, 14 are within several inches of each other and their IrDA configuration ports 76, 116, 140 (which provide a communication line to the respective IrDA transceivers 152, 154, 156) are in line. This range limitation is desirable in that it allows only one siren or light module 12, 14 to be reconfigured with a new KeyFobID at a time. Configuring a siren or light modules' KeyFobID's through the RF interface would be problematic due to the fact that any module powered-up and within RF range of the configuring remote control could be inadvertently configured.

There are two ways in which a remote control's KeyFobID can be stored in the memory of a siren or light module 12, 14: volatile or non-volatile storage. As will be described below in greater procedural detail, if a remote control's Strobes Off/Volatile Configuration button 102 is held a configuration packet is generated and sent to the siren or light module 12, 14 (through the IrDA interface) instructing it to save the remote control's KeyFobID in volatile memory only. The effect of this type of configuration is that the new KeyFobID is only valid while the siren or light module 12, 14 has been powered up since the volatile configuration. When the siren or light module 12, 14 is turned OFF then ON again, the active KeyFobID will return to the last non-volatile KeyFobID received. Alternatively, if a remote control's Siren Off/Non-Volatile Configuration button 102 is held, the siren or light module 12, 14 will store the KeyFobID into non-volatile memory. The siren or siren module 12, 14 will not only be configured to the new KeyFobID while it's powered up, but also after being switched OFF then ON again.

The remote control 16 key fob can be temporarily set to control additional siren and/or light modules 12, 14 by reconfiguring the default unit identification program of the siren and/or light modules 12, 14. It should be appreciated the configuration process uses considerably more power than standard control signal for controlling light modules 14 and siren modules 12, therefore pressing the lights OFF/temporary configuration button 102 or siren OFF/permanent configuration button 134 in the remote control 16 for extended durations will reduce the battery life of the remote. Users that frequently configure and reconfigure modules using the remote control 16 can expect more frequent battery replacement.

That being understood, to temporarily add additional light and/or siren modules 14, 12 under the control of a single remote control 16 the following procedure is used: a) Select the siren or light module or modules 12, 14 you wish to control and place the power/mode switch 68 in the REMOTE position, that is the switch 68 is pressed to the right side, (siren modules 12 should be connected to the vehicle battery); b) Locate the infrared configuration port window 116, 70 on the siren or light module 12, 14; c) Take the remote control 16 key fob you wish to use and locate the infrared configuration window 140 on the bottom; d) Carefully place the window of the infrared configuration port 140 of the remote control 16 as close as possible to the infrared configuration port 116, 70 on the siren or light module 12, 14 to be controlled; e) Next press and hold the lights off button 102 on the remote control 16 key fob (Observe the STATUS indicator light on the module being programmed; when the module is successfully reconfigured, the STATUS light will quickly blink 5-7 times and the siren or light module 12, 14 can now be controlled by the remote control 16 that just configured it); and f) Repeat this procedure for any additional siren or light modules 12, 14 to be controlled by the chosen remote control 16 key fob.

Where it is desired to return a siren or light module 12, 14 to control by its original remote control 16, cycle the power on the siren or light module 12, 14. The siren or light module 12, 14 will be returned to its default settings. Powering a siren or light module 12, 14 off will return the siren or light module 12, 14 to its default remote control 16. Also, if the light module 14 battery discharges to its cutoff voltage, the configuration will be returned to its default setting.

To permanently add additional siren or light modules 12, 14 under the control of a single remote control 16, use the following procedure (Same procedure for Siren Modules): a) Select the siren or light module(s) 12, 14 you wish to control and place the power/mode switch 68 in the REMOTE position 68b (Siren Modules should be connected to the vehicle battery); b) Locate the window for the infrared configuration port 116, 70 on the siren or light module 12, 14; c) Take the remote control 16 key fob you wish to use and locate the window for the infrared configuration port 140 on the bottom; d) Carefully place the infrared configuration port 140 as close to the infrared configuration port 116, 70 on the siren or light module 12, 14 to be controlled, as possible; e) Next press and hold the siren OFF/permanent configuration button 134 on the remote control 16 key fob (Observe the STATUS indicator light on the siren or light module 12, 14 being programmed; when the siren or light module 12, 14 is successfully reconfigured, the STATUS light will quickly blink 10-12 times and the siren or light module 12, 14 can now be controlled by the remote control 16 that just configured it); and f) Repeat this procedure for any additional siren or light modules 12, 14 to be controlled by the chosen remote control 16 key fob. The siren and/or light modules 12, 14 are now permanently assigned to control by this remote control 16, unless this procedure is repeated with a different remote control 16.

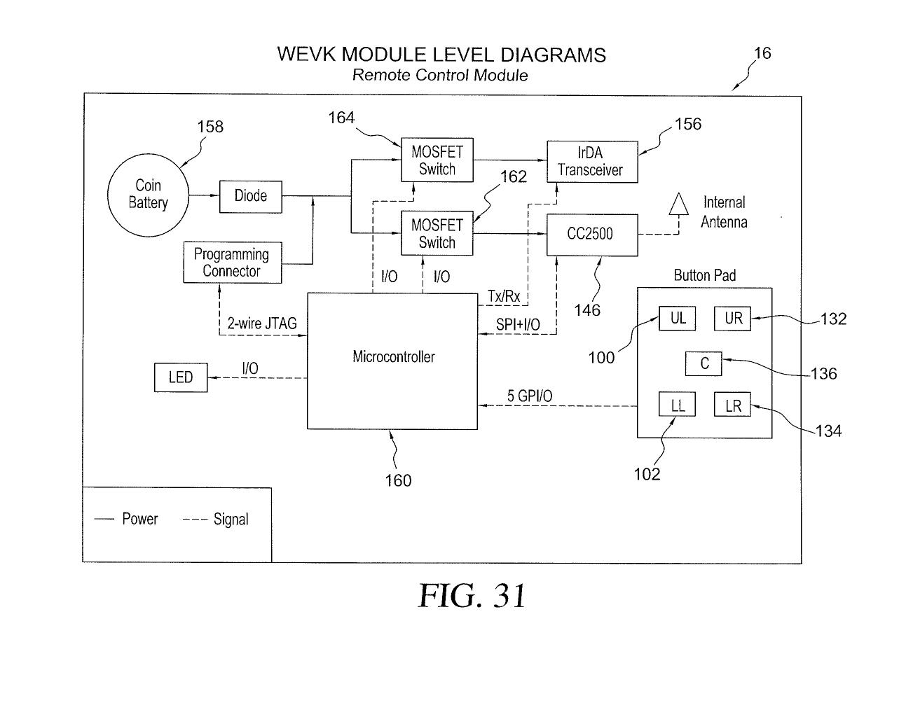

With the foregoing in mind, the basic circuitry of the remote control 16 is disclosed with reference to FIG. 31. The electric components of the remote control 16 are powered by a coin battery 158 commonly employed with currently available automobile (and other) remote controls. The remote control 16 includes a microcontroller 160 programmed for operation in accordance with the procedures set forth herein. The buttons of the remote control are linked to the microcontroller 160 for the issuance of appropriate commands via either the RF transceiver 146 or IrDA transceiver 156. The commands issued by the microcontroller 160 are passed through MOSFET switches 162, 164 to ensure proper and controlled operation of the remote control 16 in accordance with the present invention.

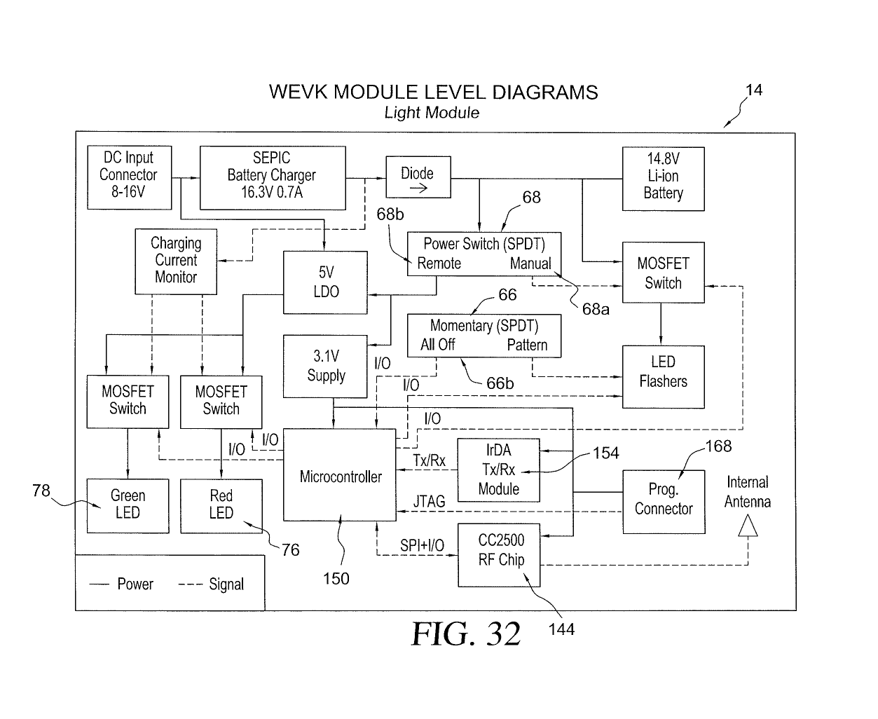

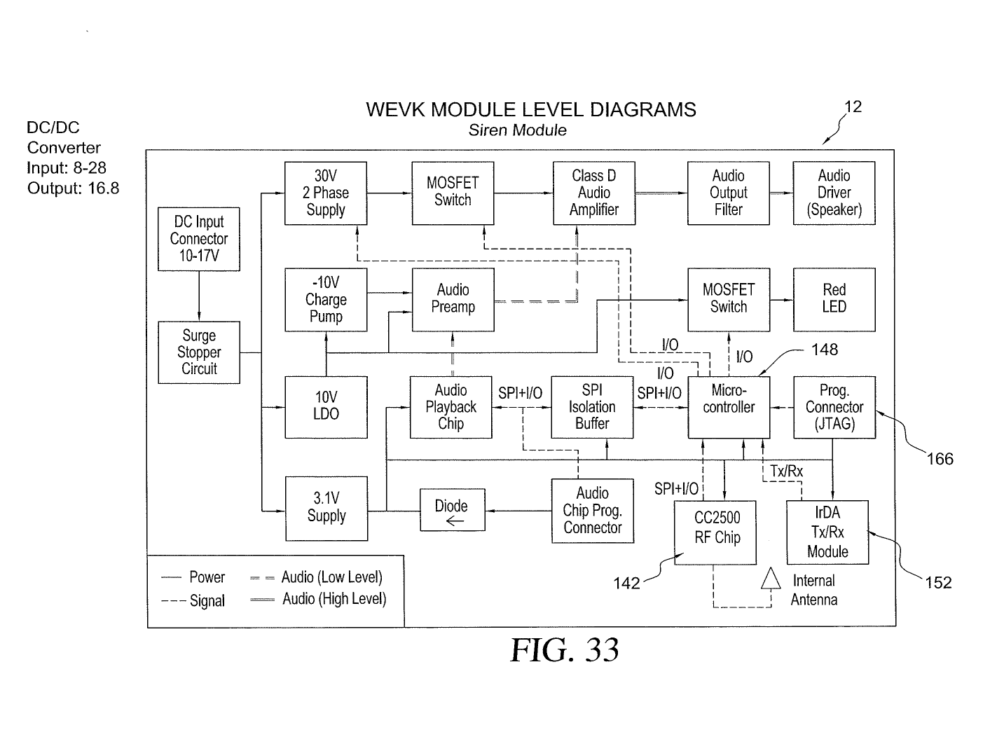

Schematic concerning the electrical components of the siren module 12 and light module 14 are also shown with reference to FIGS. 32 and 33. The components relating to horn and light features of the siren and light modules 12, 14 are conventional. However, and with reference to programming and control of the siren and light modules 12, 14, each includes an RF transceiver 142, 144 linked to a microcontroller 148, 150 for receiving, determining whether the KeyFobID matches and issuing appropriate commands for the operation of the either the siren module 12 or the light module 14. Each of the siren and light modules 12, 14 also includes an IrDA transceiver 152, 154 linked to a program connector 166, 168 and microcontroller 148, 150 for changing the KeyFobID as discussed above.

As briefly discussed above, the present system is provided with various accessories for providing power to the system 10. It should first be noted that it is not recommended to operate the light modules 14 while charging as this puts excessive loading on the charging power supply and also results in longer than normal charging time.

The light modules 14 may be charged at any time. The Lithium Ion batteries used in the light modules 14 do not develop memory like other battery chemistries. Each light module 14 has a built-in charging/monitoring circuit. The battery charger wall adapter 38 is mounted in the carrying case 18 and connected to a distribution harness with leads that feed to the individual storage compartments for the 4 light modules 14. A charging jack is located on the bottom side of each light module 14 and a mating jack is available for each module. Simply plug the jacks into the light modules 14 and then plug the main charger power cable into an appropriate wall receptacle rated at 100 to 240 VAC (50/60 Hz). The chargers monitor the battery charge level and will turn off when the battery reaches full charge. It should be noted that charging jacks are small so take care when plugging and unplugging them to avoid damage to either the charger or the modules being charged.

If required, the light modules 14 may be charged in the vehicle (using DC) without removing them from the transport case. This is accomplished by using the included cigarette lighter adapter 44. Simply disconnect the circular screw connector that attaches the wall adapter 38 to the power distribution charging jack harness 40 and screw the DC cigarette lighter adaptor 44 in its place, using care to ensure that the terminals with red markings line up as shown in the photograph below. It should be appreciated that users should always ensure that terminals marked in red are connected together. Reversing the connections will result in blown circuit protection fuses. Also, since charging batteries generates some heat, it is recommended that the transport case lid be left in the open position.

It is preferred the light modules 14 reach a minimum charging time before first use. In particular, and in accordance with a preferred embodiment of the present invention, it is preferred the light and siren modules 14, 12 be plugged into the chargers for at least 12 hours prior to first use. The batteries will not overcharge as the chargers monitor the battery charge level and stop charging once the batteries reach their fully charged state. The battery packs located in each module 14 are equipped with smart controllers that prevent overcharging and over discharging of the battery to yield maximum life and performance from the battery packs.

The light modules 14 will operate nominally for approximately 6 hours on a full battery charge, if operated in the default flash mode. Other flash modes may result in reduced run times, particularly the All Lights On with no flash pattern. Please note that unit run times can be affected by battery charge level and operating temperature as well as other factors.

The light modules 14 are equipped with a battery voltage monitoring circuit which provides the user with a GO/NO GO battery level determination. When a module 14 is first placed in the remote mode, battery status symbol will display the battery condition. If the battery is fully charged, the Green LED will illuminate for approximately 2 seconds. If the battery has insufficient charge, the Red LED will illuminate for approximately 2 seconds. After the battery condition is displayed for 2 seconds the LEDs will turn off so as to not provide a distraction to drivers and passengers. The battery monitoring circuit checks battery condition every 15 seconds and provides a quick red or green LED illumination for 50 micro-seconds. This allows users to monitor battery status at a glance. When the red LED flashes, the battery is in need of charging soon. If the green LED flashes, the battery charge is good.

If the battery status continues to flash red and is not charged, it will eventually reach the battery cutoff voltage and module operation will cease. Once this point is reached, the status LED will no longer provide a display.

Under normal operation and usage, battery replacement should not be necessary. However, should the user ever need to replace the battery, the following instructions for replacement of the battery in the light module 14 should be observed: 1) If the module requiring a new battery is installed in its protective boot, remove the boot; 2) Lay the module, light side down on a soft cloth or other non-scratch surface; 3) Remove the four (4) Phillips head screws holding the module cover in place; 4) Carefully lift the cover to access the battery retention strap; 5) Unplug the battery connector from the circuit board and lay the cover battery side up on a soft surface; 6) Note the orientation of the battery and how the wire is routed; 7) Carefully remove the four self-threading screws from the battery retention strap and lift the battery out of the battery compartment; 8) Take the replacement battery and place it back into the battery compartment in exactly the same orientation as the one you just removed, routing the battery cable in the same manner as the original; 9) Replace the battery retention strap with the 4 self-threading screws, being careful not to compress or pinch the battery cable; 10) Plug the battery connector into the connector on the circuit board; 11) Replace the module cover making sure that no wires are caught between the cover and the enclosure; 12) Replace the 4 module cover screws, taking care to not over-tighten (Excessive tightening of these screws could crack and damage the module housing); 13) The module may now be reinstalled into its protective boot; and 14) The new battery should initially be charged for a minimum of 12 hours before use.

The remote control 16 is powered using a standard CR2032, button cell Lithium battery, which is replaced in the following manner: 1) Turn Light Modules 14 to the OFF position and remove power from the siren module 12; 2) Carefully pry apart the two remote control 16 housing halves; 3) Slide the depleted battery out of the battery holder clip, noting the polarity markings; 4) Slide the new battery back into the battery holder clip, maintaining the same battery orientation and polarity; 5) Ensure that the circuit board is aligned in the housing correctly, then snap the two housing halves together; 6) Press any one of the Remote buttons to verify that the status LED illuminates; and 7) Light Modules and siren module 12 may be powered back ON. It should be noted that following replacement of the remote control 16 battery, all light and siren modules being employed in accordance with the system, should be powered off and then back on in order to properly synchronize control signals. This is only necessary if the battery of the remote control 16 is replaced while modules are in operation.

While the preferred embodiments have been shown and described, it will be understood that there is no intent to limit the invention by such disclosure, but rather, is intended to cover all modifications and alternate constructions falling within the spirit and scope of the invention.

1. A wireless system for an emergency vehicle, comprising:
at least one siren module;
at least one light module; and
a remote control in communication with the at least one siren module and the at least one light module;
wherein each of the at least one siren module, at least one light module and remote control are programmable for facilitating selective communication.

2. The wireless system according to claim 1, wherein at least 4 light modules are included.

3. The wireless system according to claim 1, wherein the at least one siren module includes an integral mounting bracket.

4. The wireless system according to claim 1, wherein the at least one light module includes a mounting bracket.

5. The wireless system according to claim 4, wherein multiple mounting brackets are included, and the mounting brackets include an L-shaped mounting bracket, spring hinge mounting bracket and a hinged mounting bracket.

6. The wireless system according to claim 1, wherein the at least one light module includes an ALL OFF command turning off the complete system.

7. The wireless system according to claim 1, wherein the at least one siren module includes an infrared configuration port.

8. The wireless system according to claim 7, wherein the at least one siren module includes a unique identification number in memory.

9. The wireless system according to claim 8, wherein the at least one siren module includes a volatile memory and a non-volatile memory.

10. The wireless system according to claim 1, wherein the at least one light module includes an infrared configuration port.

11. The wireless system according to claim 10, wherein the at least one light module includes a unique identification number in memory.

12. The wireless system according to claim 10, wherein the at least one light module includes a volatile memory and a non-volatile memory.

13. The wireless system according to claim 1, wherein the remote control includes a lights ON/pattern select button, a lights OFF/temporary configuration button, a siren ON/tone select button, a siren OFF/permanent configuration button, and a horn blast button.

14. The wireless system according to claim 1, wherein the remote control includes an infrared configuration port.

15. The wireless system according to claim 14, wherein each remote control is associated with a unique unit identification number and each of the at least one siren module and at least one light module store a unique identification number in memory.

16. The wireless system according to claim 15, wherein the remote control issues data packets with the associated unique unit identification number allowing for control of light and siren modules associated with the same unique unit identification number.

17. The wireless system according to claim 15, wherein the remote control issues the data packets using RF communications.

18. The wireless system according to claim 1, wherein the remote control, at least one siren module and at least one light module communicate via IrDA.

19. The wireless system according to claim 1, wherein each remote control is associated with a unique unit identification number and each of the at least one siren module and at least one light module store a unique identification number in memory, the remote control including an infrared configuration port for communication with communication ports of respective at least one siren module and at least one light module for changing the unique unit identification number stored within the memory of the at least one siren module and at least one light module.
